(19) United States
(12) Patent Application Publication
(10) Pub. No.: US 2017/0260665 A1
(43) Pub. Date: Sep. 14, 2017

(54) THREE-DIMENSIONALLY PATTERNED NON-WOVEN HAVING STRESS RECOVERY

(71) Applicant: First Quality Nonwovens, Inc., Great Neck, NY (US)

(72) Inventors: Michael KAUSCHKE, PRIEN (DE); Michele MILLER, Weatherly, PA (US); John C. PARSONS, Dallas, PA (US); Peter Zajaczkowski, Greenville, SC (US)

(21) Appl. No.: 15/453,695

(22) Filed: Mar. 8, 2017

Related U.S. Application Data
(60) Provisional application No. 62/305,415, filed on Mar. 8, 2016.

(51) Int. Cl. D04H 3/16; B32B 5/26; D06C 15/08; D04H 3/11; B32B 3/30; D06C 15/02; B32B 5/02; D04H 3/14

(52) U.S. Cl. CPC D04H 3/16; B32B 5/022; B32B 5/26; D04H 3/14; D04H 3/11; B32B 3/30; D06C 15/02; D06C 15/08; D10B 2403/0331; D10B 2501/00; B32B 2250/20; B32B 2307/724; B32B 2307/722; B32B 2437/00

(57) ABSTRACT

A nonwoven web made of substantially continuous fibers and comprising a three-dimensional pattern of protruding closed shapes, wherein the nonwoven web has a compression recovery of at least 30% after being compressed at 1 psi for 24 hours.

### FIELD OF THE INVENTION

The present invention relates to nonwoven material having a three-dimensional pattern.

### BACKGROUND OF THE INVENTION

Nonwoven materials are widely used in a host of consumer products. For example, wearable disposable products, such as diapers and the like, are typically formed of, or contain nonwoven materials.

### SUMMARY OF THE INVENTION

It is desirable for nonwoven products to have a three-dimensional pattern on an exterior surface that provides increased bulk and an enhanced visual appeal. In addition, nonwovens having a three-dimensional patterned surface can provide improved comfort by reducing the amount of material that comes into contact with a wearer's skin in body facing applications.

A pre-bonded nonwoven web according to an exemplary embodiment of the present invention is formed of substantially continuous fibers and has a resilient three-dimensional pattern formed using a pair of rolls. One of the pair of rolls includes a pattern of cavities into which the web is pressed by the other roll to form corresponding protrusions that make up the pattern in the web.

Accordingly, it is an object of the invention to provide a nonwoven web comprising substantially continuous fibers, the nonwoven web further comprising a pattern of protruding closed shapes, whereby the nonwoven has a compression recovery of at least 30% after being compressed at 1 psi for 24 hours. It is another object of the invention to provide a nonwoven web comprising substantially continuous fibers, the nonwoven web further comprising a pattern of protruding closed shapes, whereby the nonwoven has a compression recovery of at least 40% after being compressed at 1 psi for 24 hours.

Another object of the invention is to provide a nonwoven web, whereby the protruding shapes have an average diameter of between 2 mm and 15 mm and whereby the protrusions have a lower density and higher air permeability than the regions between the protrusions. In another object of the invention, the protruding shapes have a minimum width of between 2 mm and 5 mm.

It is a further object of the invention to provide an absorbent article having the nonwoven web incorporated therein or thereon.

It is still another object of the invention to provide a method of manufacturing a nonwoven web by introducing a precursor nonwoven web comprised of substantially continuous fibers into a heated nip located between a first heated roll comprising an engraved pattern of cavities and a second roll having a deformable and resilient outer surface; and pressing regions of the precursor nonwoven web into the cavities and plastically deforming the precursor nonwoven web to form protrusions.

It is another object of the invention to provide a method of manufacturing a nonwoven web by introducing a precursor, pre-bonded nonwoven web comprised of substantially continuous fibers into two sequential nips formed by a heated steel roll and two cooperating rubber rolls, whereby the steel roll is engraved with a series of repeating cavities.

A nonwoven web according to an exemplary embodiment of the present invention is made of substantially continuous fibers and comprises a three-dimensional pattern of protruding closed shapes, wherein the nonwoven web has a compression recovery of at least 30% after being compressed at 1 psi for 24 hours.

According to an exemplary embodiment, the nonwoven web has a compression recovery of at least 40% after being compressed at 1 psi for 24 hours.

According to an exemplary embodiment, the protruding closed shapes comprise shapes of a type selected from the group consisting of: hexagonal, circular and oblong.

According to an exemplary embodiment, the three dimensional pattern comprises a matrix that surrounds the protruding closed shapes.

According to an exemplary embodiment, portions of the nonwoven web that form the protruding closed shapes have a density that is less than that of portions of the nonwoven web that form the matrix.

According to an exemplary embodiment, the matrix that surrounds the protruding closed shapes forms a continuous, inter-connecting network.

According to an exemplary embodiment, the network is configured to hold the nonwoven web dimensionally stable under monoaxial and/or multi-axial stress.

According to an exemplary embodiment, the network is configured to allow the web to recover into its original dimensions after application of stress forces and release of the stress forces.

According to an exemplary embodiment, portions of the nonwoven web that form the protruding closed shapes have an air permeability that is higher than that of portions of the nonwoven web that form the matrix.

According to an exemplary embodiment, the matrix takes up 15% to 40% of an entire surface area of the nonwoven web.

According to an exemplary embodiment, the nonwoven web comprises one or more layers of substantially continuous fibers.

According to an exemplary embodiment, the nonwoven web is a spunbond, meltblown or spunbond-meltblown-spunbond web.

According to an exemplary embodiment, the nonwoven web is made from mono-component, bi-component or multi-component fibers.

According to an exemplary embodiment, the fibers are thermally pre-bonded, hydroentangled, air bonded or thermally tack bonded.

A method of manufacturing a nonwoven web according to an exemplary embodiment of the present invention comprises: introducing a precursor nonwoven web comprised of substantially continuous fibers into a nip formed by a heated first roll comprising a pattern of cavities and a second roll comprising a deformable and resilient outer surface; and pressing regions of the precursor nonwoven web into the cavities to plastically deform the precursor nonwoven web to form a three-dimensional pattern of protruding closed shapes on a surface of the precursor nonwoven web.

A method of manufacturing a nonwoven web according to an exemplary embodiment of the present invention comprises: introducing a precursor nonwoven web comprised of substantially continuous fibers into a first nip, formed by a heated first roll comprising a pattern of cavities and a second roll comprising a deformable and resilient outer surface, and a second nip, formed by the heated first roll and a third roll comprising a deformable and resilient outer surface; and pressing regions of the precursor nonwoven web into the cavities in a synchronized manner along a circumferential portion of the first roll between the first and second nips to plastically deform the precursor nonwoven web in a repeating step to form a three-dimensional pattern of protruding closed shapes on a surface of the precursor nonwoven.

A method of manufacturing a nonwoven web according to an exemplary embodiment of the present invention comprises: introducing a precursor nonwoven web comprised of substantially continuous fibers into two or more nips, each of the two or more nips comprising a heated first roll comprising a pattern of cavities and a respective second roll comprising a deformable and resilient outer surface; and pressing regions of the precursor nonwoven web into the cavities in a synchronized manner along a circumferential portion of the first roll between the two or more nips to plastically deform the precursor nonwoven web in a repeating step to form a three-dimensional pattern of protruding closed shapes on a surface of the precursor nonwoven.

According to an exemplary embodiment, pressure in the nip is within a range of 10 N/mm to 120 N/mm.

According to an exemplary embodiment, the first roll is heated to a temperature of 80° C. to 150° C.

According to an exemplary embodiment, the first roll is made of steel.

According to an exemplary embodiment, the outer surface of the second roll is made of rubber.

According to an exemplary embodiment, the outer surface of the third roll is made of rubber.

According to an exemplary embodiment, the cavities have a depth of 0.5 mm to 5.0 mm.

According to an exemplary embodiment, the first roll comprises a matrix of interconnected surfaces that surround the cavities.

According to an exemplary embodiment, the interconnected surfaces have a width of 0.5 mm to 2 mm.

According to an exemplary embodiment, the cavities define closed shapes.

According to an exemplary embodiment, the closed shapes comprise shapes selected from the group consisting of: circular, oval, square, hexagon, pentagon and octagon.

According to an exemplary embodiment, the method further comprises prebonding the precursor nonwoven web prior to the introducing step.

### BRIEF DESCRIPTION OF THE DRAWINGS

The above and related objects, features and advantages of the present invention will be more fully understood by reference to the following, detailed description of the preferred, albeit illustrative, embodiments of the present invention when taken in conjunction with the accompanying figures, wherein:

FIG. 1 is a front, perspective view of a steel roll having an engraved hexagonal pattern thereon according to an exemplary embodiment of the invention.

FIG. 2A is a planar view of a repeating hexagonal pattern engraved on a roll used to form three-dimensional patterns according to an exemplary embodiment of the invention.

FIG. 2B is a side, cross-sectional view of the engraved pattern shown in FIG. 2A.

FIG. 3 is an enlarged, schematic cross-sectional view of a segment of the engraved pattern shown in FIG. 2A.

FIG. 4A is a schematic view of a waved pattern engraved on a roll used to form three-dimensional patterns according to an exemplary embodiment of the invention.

FIG. 4B is a side, cross-sectional view of the engraved pattern shown in FIG. 4A.

FIG. 5 is a side, partial cross-sectional schematic view of a rubber roll intermeshing with pattern imparting structures on a steel roll according to an exemplary embodiment of the invention.

FIG. 6 is a top, perspective view of a section of a nonwoven web having a three-dimensional pattern formed by a roll having the pattern shown in FIG. 2A according to an exemplary embodiment of the invention.

FIG. 7 is a bottom, perspective view of the section of nonwoven web shown in FIG. 6.

FIG. 8A is a planar view of a repeating hexagonal pattern engraved on a roll used to form three-dimensional patterns according to an exemplary embodiment of the invention.

FIG. 8B is a side, cross-sectional view of the engraved pattern shown in FIG. 8A.

FIG. 9A is a planar view of repeating abutting circular patterns engraved on a roll used to form three-dimensional patterns according to an embodiment of the invention.

FIG. 9B is a side, cross-sectional view of the engraved pattern shown in FIG. 9A.

FIG. 9C is a planar view of overlapping repeating circular patterns engraved on a roll used to form three-dimensional patterns according to an embodiment of the invention.

FIG. 10A is a planar view of repeating oblong patterns engraved on a roll used to form three-dimensional patterns according to an embodiment of the invention.

FIG. 10B is a side, cross-sectional view of the engraved pattern shown in FIG. 10A.

FIG. 11 is a side, cross-sectional schematic view of a three-dimensional patterned nonwoven web formed by a steel roller and two cooperating rubber rolls which form two serial nips according to an exemplary embodiment of the invention.

FIG. 12 is a comparative table showing properties measured for three-dimensional patterned nonwoven webs according to exemplary embodiments of the invention as compared to a nonwoven web control.

### DETAILED DESCRIPTION OF THE INVENTION

The present invention is directed to a nonwoven web having a resilient three-dimensional surface pattern and a method of manufacturing the same.

In a preferred embodiment of the invention, the nonwoven web includes one or more layers of substantially continuous fibers or filaments and is a spunbond, meltblown and/or spunbond-meltblown-spunbond (“SMS”) web. In embodiments of the invention, the nonwoven web can be made from mono component, bi-component, or multi-component fibers. The fibers may be thermally pre-bonded, hydro-entangled, air bonded or thermally tack bonded in embodiments of the invention.

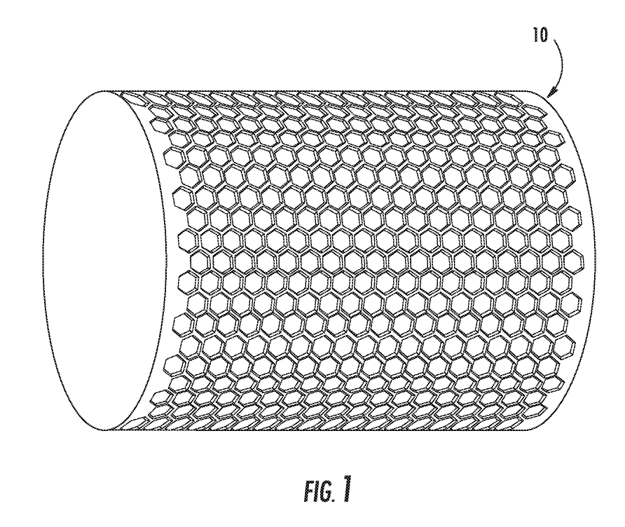

In embodiments of the invention, a nonwoven web is passed through heated nip formed by a pair of counter-rotating rolls that imparts a three-dimensional pattern to the nonwoven web. The first roll has an exterior surface that is a patterned steel (or other hard, engravable material) die with the pattern engraved into the roll to form a series of cavities. For example, FIG. 1 shows a steel roll 10 having repeating hexagonal cavities on its outer surface. The second roll has a rubber (or other resilient, compressible material) exterior layer and is a substantially cylindrical drum (not shown). The two rolls are arranged such that the rubber of the second roll comes into contact with the steel roll at a nip between the rolls, which results in the rubber pressing into the cavities making up the pattern of the steel roll. In an embodiment of the invention, the nip pressure ranges from 10 to 120 N/mm. The first roll is heated to a temperature of between 80° C. to 150° C. The nonwoven web is introduced into the nip whereby the second roll forces the web into the cavities of the pattern of the first roll while holding the nonwoven web in place where the first roll is flat. This action imparts a three-dimensional pattern to the nonwoven web corresponding to the pattern engraved into the first roll.

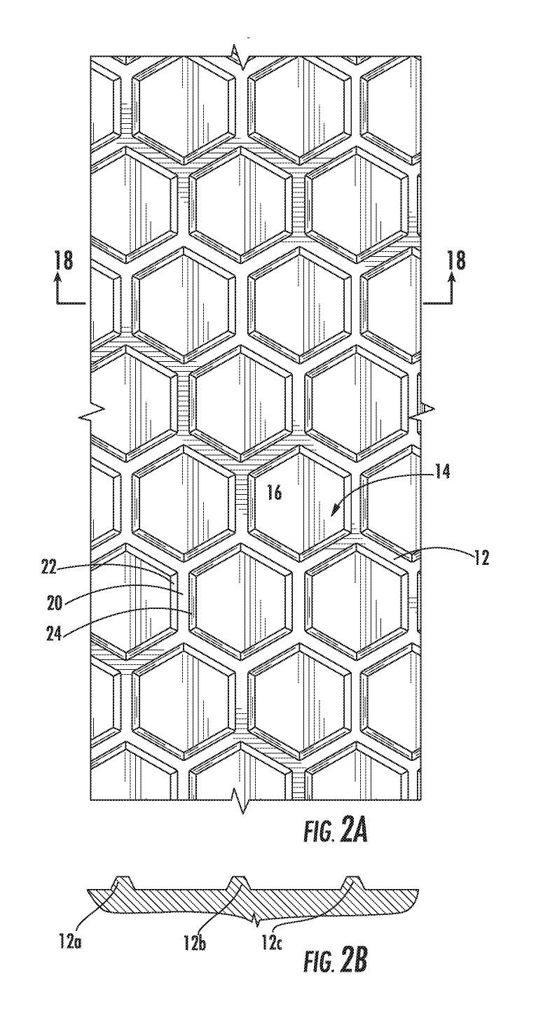

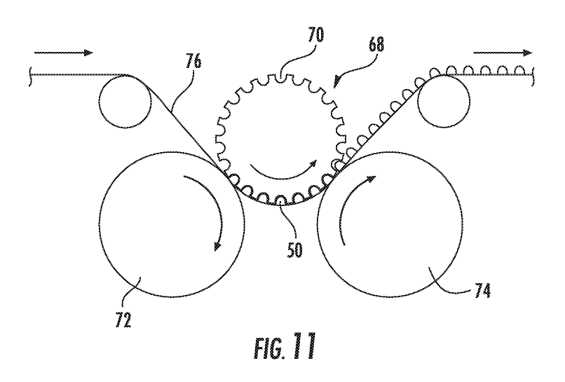

FIG. 2A shows an enlarged segment of the outer surface of the steel roll 10 shown in FIG. 1. As shown, a series of interconnected ridges 12 form hexagonal cavities 14. Each cavity 14 has a floor surface 16 surrounded by the ridges 12, whereby the floor surface 16 is recessed with respect to the top surface of the ridges 12. (Although the rolls of the present invention are substantially cylindrical in shape, the patterns shown in FIGS. 2-10 are schematically depicted as planar surfaces. Moreover, only the external surface of rolls are depicted in order to illustrate the negative patterns that interface with the nonwoven web and impart corresponding patterns thereto. The negative patterns provided on the circumferential outer surface of a steel roll may be referred to as the “pattern imparting structures” herein.) FIG. 11 shows a cross-sectional view of another embodiment of the invention, whereby a single steel roll and two rubber rolls are utilized to create successive nips used to impart three-dimensional patterns on a nonwoven web.

FIG. 2B shows a side cross-sectional view (e.g. taken along the plane depicted by line 18) of a segment of the pattern imparting structures shown in FIG. 2A. Side cross-sectional views of ridges 12a, 12b and 12c are shown.

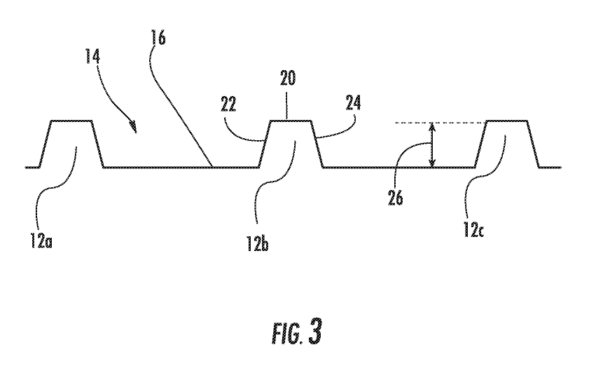

FIG. 3 shows a schematic enlarged cross-sectional view of pattern imparting structures shown in FIG. 2B. As shown, each ridge (e.g. 12b) has an upper flat surface 20 and two sidewalls (e.g. left side wall 22, and right sidewall 24). Sidewalls emanate from floor surfaces 16 of cavities 14 and terminate in flat surface 20. In a preferred embodiment, sidewalls 22, 24 extend upwardly at an angle. For example, left side wall 22 slopes toward flat surface 20 of ridge 12b (to the right in the orientation shown) and right side wall 24 slopes toward flat surface 20 of ridge 12b (toward the left in the orientation shown).

The height of ridges 12 (i.e. the distance between the plane of surface 20 and the floor 16 of cavity (e.g. depicted by line 26)) defines the depth of the cavity 14. In embodiments of the invention, ridges may be between 0.5 mm and 5.0 mm in height (and correspondingly, depth of cavities range between 0.5 mm and 5.0 mm in height in embodiments of the invention). The term “cavity” herein shall refer to the interior space of a closed geometric shape being defined by a floor surface and surrounding respective sidewalls of respective ridges and to spaces between substantially straight or waved ridges.

As shown in FIG. 1, the ridges 12 form a matrix of interconnected surfaces each having a top surface 20 that occupy a first plane. The floor surfaces 16 of cavities 14 are distinct isolated areas that lie on a plane that is lower than that of top surfaces 20 of ridges 12. In exemplary embodiment the width of the ridges can be from between 0.5 mm to 2 mm. It will be understood by those of ordinary skill in the art that any of various patterns may be used in different embodiments of the invention. It is understood that the roll patterns disclosed herein are exemplary and in embodiments of the invention, a steel roll may be provided with any interconnected matrix of ridges, whereby the ridges form a network of geometric shapes, each of the geometric shapes having a perimeter formed by ridges and an interior area within the perimeter, whereby the interior area has a floor surface that is recessed with respect to the top surfaces ridges. In preferred embodiments, the geometric shapes are closed shapes, whereby the ridges completely surround a cavity. For example, the ridges may form circles, ovals, squares, hexagon, pentagons, octagons, or any similar closed geometric shape.

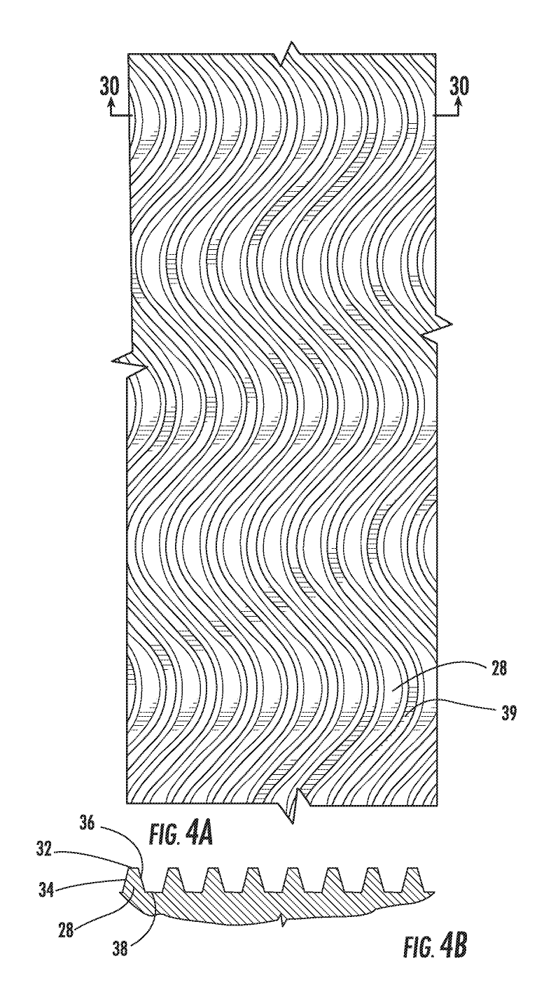

In another embodiment of the invention, rather than a network of ridges, a steel roll having a pattern including a series of straight or wavy ridges may be used. For example, referring to FIG. 4A an engraved pattern is shown having a series of undulating or wavy ridges 28. As shown, the roll die pattern is comprised of a series of wavy ridges 28 where respective convex areas of wavy ridges align with respective concave areas of neighboring ridges. In another embodiment of the invention, the ridges are substantially parallel straight ridges that extend along the longitudinal axis of the roll.

FIG. 4B shows a side cross-sectional view (e.g. taken along the plane depicted by line 30) of a segment of the pattern imparting structures shown in FIG. 4A. Side cross-sectional views of the waved ridges 28 are shown, whereby each ridge 28 has an upper flat surface 32 and two sidewalls (e.g. left side wall 34, and right sidewall 36). Sidewalls emanate from floor surfaces 38 between each ridge 28. In a preferred embodiment, sidewalls 34, 36 extend upwardly at an angle. For example, left side wall 34 slopes toward flat surface 32 of ridge 28 (to the right in the orientation shown) and right side wall 36 slopes toward flat surface 32 of ridge 28 (toward the left in the orientation shown). In embodiments of the invention, flat surfaces 32 of ridges 28 are between approximately 0.5 mm and 0.2 mm in width, and the height of ridges (i.e. substantial distance between floor surface 38 and top surface 32) is between 0.5 mm and 5.0 mm. The distance between respective ridges 28 is approximately from 1.0 mm to 5.0 mm in embodiments of the invention. The amplitudes of respective waved ridges 28 may vary in different embodiments of the invention, and in one embodiment the wavelength of waved ridges is between 10 mm and 50 mm.

The fibers that make up the nonwoven webs of the present invention are not limited to a particular material. For example, the fibers can be made from polyolefins such as polypropylene and polyethylene or can be made from polyester, polylactic acid (PLA), polyamide or cellulosic fibers and combinations thereof. Bicomponent and multicomponent fibers may be used as may fibers with circular or noncircular polygonal cross sections. Splittable fibers, typically multicomponent fibers may also be used.

In embodiments of the invention, the fibers are initially bonded using methods known in the art, such as, thermal bonding, ultrasonic bonding, through air bonding, hydro-engorgement, hydro-entanglement or combinations thereof. (Nonwoven webs bonded in an initial bonding step may be referred to as “prebonded” herein.)

In embodiments of the invention, the “prebonded” nonwoven web, is introduced into a pair of rolls as described above. In other embodiments, the nonwoven web is not prebonded prior to being passed between the rolls.

The steel roll and rubber roll are placed in close contact with one another such that the rolls intermesh, with the rubber roll exerting a significant amount of pressure on the steel roll.

In embodiments of the invention, the rotating pair of intermeshing rolls compress segments of the nonwoven web and drive the segments into respective cavities. That is, the distance between respective floor surfaces 16 of cavities 14 and the circumferential outer surface of the rubber roll is greater than the distance between respective top surfaces 20 of ridges and the circumferential outer surface of the rubber roll. As such, the regions of the nonwoven web that are located between the top surfaces 20 of ridges 12 and the rubber roll are compressed and held in place. On the other hand, the rubber roll conforms to the shape of the cavities 14, thereby driving the corresponding regions of the nonwoven web into the cavities. Thus, regions of the nonwoven web that are aligned with a cavity are pressed into the cavity by the rubber roll to form protrusions in the web, while the portions of the nonwoven web aligned with the ridges (the perimeter area around a geometric shape) are compressed between the rubber roll and the flat surfaces 20 of ridges 12.

While the regions of the nonwoven web that are contacted by flat surfaces 20 of the roll 10 are held in place and compressed, the regions of the nonwoven web in between the ridges (i.e. that align with the cavities 14) plastically deform into the cavities 14, resulting in an increased surface area for those regions. In embodiments of the invention, the force applied by the rubber roll against the ridges is sufficient to secure the nonwoven web there between such that the nonwoven web in these regions undergoes less deformation than the nonwoven web forced into the cavities. In embodiments of the invention, the step of compressing nonwoven web areas aligned with ridges 12 results in the creation of thermal bonds between the fibers and the formation of a bonding pattern. If the nonwoven web included an initial bonding pattern the secondary bonding pattern thus formed can have a relatively lower degree of bonding.

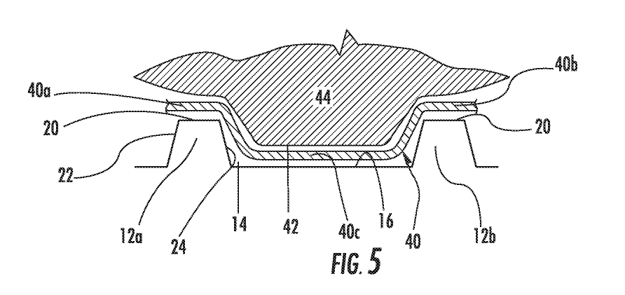

FIG. 5 shows a schematic side cross-sectional view of a segment of pattern imparting structures on the outside surface of a steel roll, a rubber roll and a nonwoven web in the process of being pressed there between. As shown, a nonwoven web 40 is pressed between the outer surface 42 of rubber roll 44 on one side and pattern imparting structures of a heated steel roll on the other side. In embodiments of the invention, nonwoven web area (40a) between top surface 20 of ridge 12a and nonwoven web area (40b) between top surface 20 of ridge 12b is held in place and compressed by outside surface 42 of rubber roll 44 bearing against top surfaces 20 of ridges 12a, 12b. Nonwoven web area 40c that is aligned with cavity 14 is forced into the same by a deformed section of rubber roll 44 inserting into cavity area between the ridges 12a, 12b.

Segments of nonwoven web that are pressed into cavity 14 are stretched into domes or protrusions substantially sized and shaped according to the contours of cavity 14. (Although FIG. 5 shows two dimensional representation of a nonwoven web being stretched into a cavity formed by floor surface 16 and sidewalls 24, 22 of respective ridges, it will be understood that a cavity may have five or more sides or may be formed in any of other three-dimensional geometric shapes.)

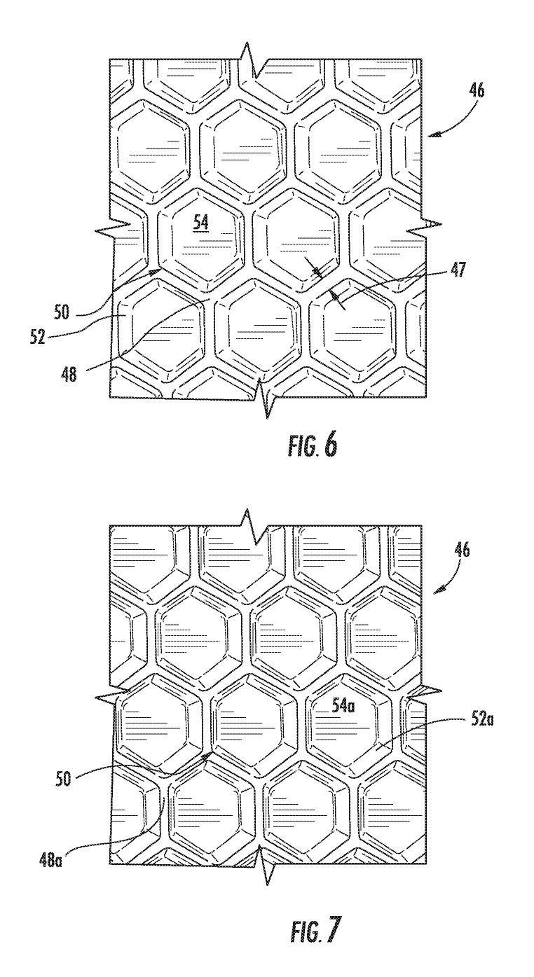

FIG. 6 shows a front view of a section of a nonwoven web 46 that has a three-dimensional pattern imposed thereon according to an embodiment of the invention. As shown, areas of compressed fiber form an interconnected matrix 48. Matrix 48 is formed by compression of the rubber roll against ridges 12. In embodiments of the invention, matrix 48 forms a pattern of repeating geometrical shapes, such as hexagons as shown. Nonwoven web areas between the matrix 48 protrude from the plane occupied by matrix 48. For example, FIG. 6 shows a series of protrusions 50 extending upwardly from matrix 48. Protrusions 50 are formed by stretching the nonwoven web areas between the matrix 48 and shaping them substantially into the shapes of respective cavities on a steel roll. Protrusions 50 have surrounding walls 52 that emanate from matrix 48 and terminate in a substantially flat or curved upper surface 54. Because protrusions 50 are formed via material stretching, the nonwoven material forming the same is less dense than the material forming the matrix 48. While matrix 48 occupies a plane that is substantially parallel, projections 50 extend out of this plane with upper surfaces 54 of projections 50 substantially occupying a separate plane.

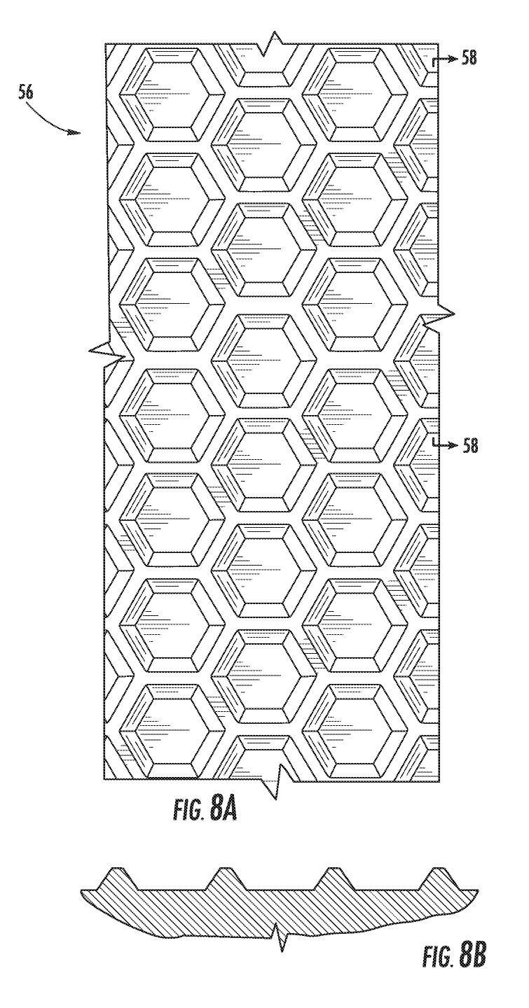

FIG. 7 shows the reverse side of the three-dimensionally patterned nonwoven web of FIG. 6, where the underside surfaces of protrusions are seen. As shown, protrusions 50 comprise concave areas or pockets having underside walls 52a that project downward from underside of matrix 48a and terminate in a substantially flat or curved surface 54a. In embodiments of the invention, respective upper surfaces 54 of protrusions 50 form the top surface of a nonwoven web, whereas, the underside of matrix 48a forms the bottom surface of the web.

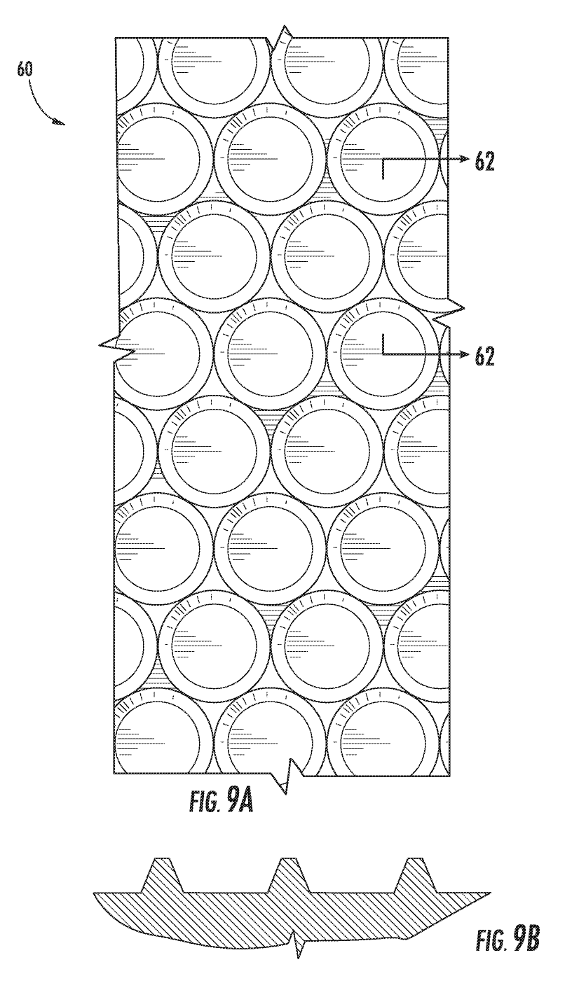

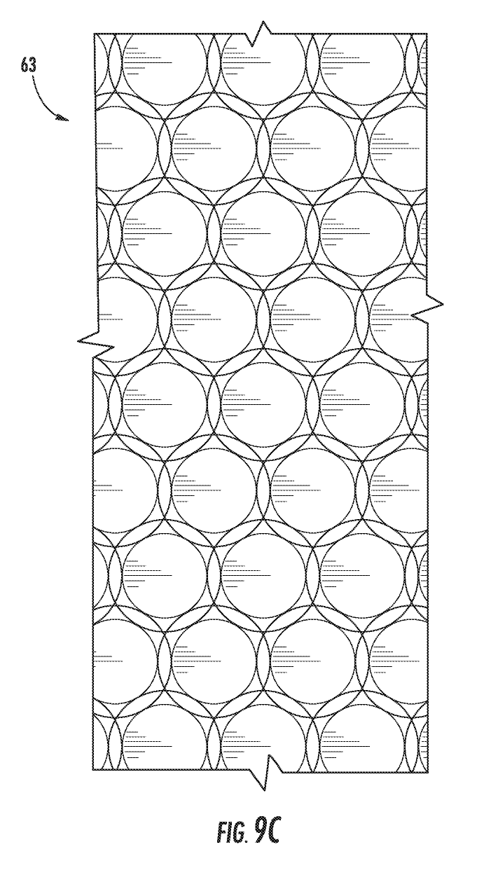

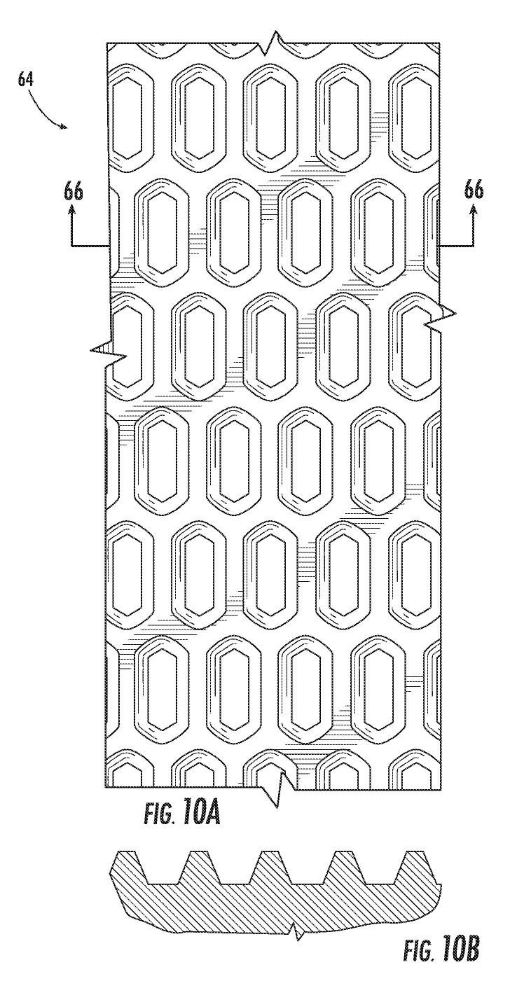

It will be understood that although embodiments of the invention were described with reference to the hexagonal patterns shown in FIGS. 1-5 and 6-7, any of various patterns and shapes are possible, all of which are within the teaching of the invention. For example, FIG. 8A shows an enlarged segment 56 of the outer surface of a steel roll having hexagonal patterns that are smaller and differently oriented than those of FIG. 2. FIG. 8B shows a side cross-sectional view (e.g. taken along the plane depicted by line 58) of a segment of the pattern imparting structures shown in FIG. 8A. FIG. 9A shows an enlarged segment 60 of the outer surface of a steel roll having abutting circular patterns according to an embodiment of the invention. FIG. 9B shows a side cross-sectional view (e.g. taken along the plane depicted by line 62) of a segment of the pattern imparting structures shown in FIG. 9A. FIG. 9C shows a segment 63 of the outer surface of a steel roll having overlapping circular patterns according to an embodiment of the invention. FIG. 10A shows an enlarged segment 64 of the outer surface of a steel roll with a pattern of oblong elements according to an embodiment of the invention. FIG. 10B shows a side cross-sectional view (e.g. taken along the plane depicted by line 66) of a segment of the pattern imparting structures shown in FIG. 10A.

FIG. 11 shows a method of forming a three-dimensionally patterned nonwoven web according to embodiments of the invention where a nonwoven web is introduced into at least two successive nips. For example, FIG. 11 shows a nonwoven web introduced into successive nips formed by a steel roll and two corresponding intermeshing rubber rolls. As shown, a central steel roll 68 intermeshes with a first rubber roll 72 and a second rubber roll 74. Steel roll 68 has a pattern of cavities 70 on its outer surface. The rubber rolls 72, 74, respectively, have deformable and resilient outer surfaces that press against the nonwoven web and push the nonwoven web into the cavities 70 of the steel roll 68. In embodiments of the invention, the steel roll is heated (e.g. to a temperature of between 80° C. to 150° C.), whereas the rubber rolls 72, 74 are not heated. A precursor nonwoven web is introduced into the nip formed by steel roll 68 and first rubber roll 72 (“first nip”), where a three dimensional pattern is imparted to the precursor nonwoven web 76. As the steel roll 68 rotates while carrying the nonwoven web 76, the nonwoven web is introduced into a second nip where a second rubber roll 74 intermeshes with steel roll 68. The nonwoven web 76 is again compressed between the second rubber roll 74 and the steel roll 68 and the pattern of the nonwoven web is reinforced.

In embodiments of the invention, the respective rolls are synchronized such that the pattern imparted onto the nonwoven web by the first nip is maintained in register with corresponding cavities of the steel roll. For example, as shown, rubber roll 72 intermeshes with steel roll 68 at a first quadrant (e.g. bottom left) and rubber roll 74 intermeshes with steel roll 68 at a second, substantially opposite quadrant (e.g. bottom right).

It will be understood that the method described with respect to geometric patterns also applies to embodiments of the invention where a steel roll having a pattern of substantially parallel ridges or wavy ridges (as shown in FIG. 4) is used. That is, with reference to FIGS. 4A and 4B, respective top surfaces 32 of ridges 28 contact a nonwoven web and compresses the same. An intermeshing rubber roll drives segments of nonwoven web into cavities 39.

In embodiments of the invention, a sheet of nonwoven web maintains its perimeter dimensions after being imparted with three-dimensional patterns as described. That is, for example, a precursor nonwoven web measuring 1 meter by 1 meter, will measure approximately 1 meter by 1 meter after being imparted with three dimensional patterns. In other embodiments of the invention a nonwoven web imparted with three-dimensional patterns as described will maintain at least 90% of its original perimeter dimensions.

In embodiment of the invention, the protrusions have a surface area of at least 1.1 times greater than the surface area prior to deformation. In embodiments of the invention the ratio of precursor surface area to the surface area after deformation is in the range of 1:1.1 to 1:2.5. The width 47 of the lines forming matrix 48 determines the distance between protrusions. In embodiments of the invention, the ratio of the width 47 of matrix to a central point of a protrusion is from 1:3 to 1:15, more preferably, 1:5 to 1:10. In embodiments of the invention, the percentage of matrix area out of the entire area of a nonwoven web is in the range of 15% to 40%.

As stated, the matrix 48 of a three-dimensionally patterned nonwoven web according to an embodiment of the invention comprises high density areas with increased bonding, whereas, the protrusions are stretched, lower density areas. This configuration provides enhanced material recovery in view of several structural factors. The higher density and higher degree of bonding in matrix 48 provides a relatively rigid skeleton which can confer a degree of tensile strength as well as elasticity. In addition the increased resilience of matrix 48 can allow the three-dimensionally patterned nonwoven web to recover from being stretched such that three-dimensional pattern and bulk is preserved.

In addition, because protrusions 50 are formed by stretching segments of the nonwoven web material, the material properties of protrusions are irreversibly altered. That is, each protrusion (surrounding walls 52 and top surface 54) occupies more surface area than a planar area of a corresponding geometric shape. Thus, protrusions are required to extend in a direction away from matrix 48. As such, in the event that protrusions become compressed as a result of pressing force (e.g. in the z direction), they will subsequently rebound, substantially to their original shape.

The following are examples demonstrating stress recovery of the three-dimensionally patterned nonwoven web according to embodiments of the invention.

### Example 1

A 20 gsm polypropylene spunbond nonwoven web was initially thermally-bonded and then introduced into a pair of intermeshing rolls with a steel patterning roll having the pattern of cavities shown in FIG. 10. The cavities in the pattern were approximately 2.5 mm wide and about 4.82 mm in length. The nonwoven web had an 18% bond area and a width of 300 mm. The line speed was 20 m/min. The steel roll was held at a temperature of 130° C. The opposing rubber roll had a hardness of 75 SH-A and the nip pressure was 70 N/mm.

The bulk of the pre-patterned precursor material was measured using a caliper. The process of forming three-dimensional patterns generated a 165% increase in material bulk as indicated by a caliper reading taken after the patterns were formed. After being compressed at 1 psi for 24 hours, the nonwoven web recovered to 89% of its initial bulk after about 10 minutes, as indicated by a caliper reading taken about 10 minutes after the compression was terminated.

### Example 2

A 20 gsm polypropylene spunbond nonwoven web was initially thermally-bonded and then introduced into a pair of intermeshing rolls with a steel patterning roll having the pattern of hexagonal elements shown in FIG. 8. The distance between opposing pairs of parallel walls in the hexagonal elements of the pattern was about 4.1 mm. The nonwoven web had an 18% bond area and a width of 300 mm. The line speed was 20 m/min. The steel roll was held at a temperature of 130° C. The opposing rubber roll had a hardness of 75 SH-A and the nip pressure was 70 N/mm.

The process of forming three-dimensional patterns generated a 335% increase in material thickness relative to the precursor material. After a 24 hour compression at 1 psi, the nonwoven recovered to 79% of its initial bulk after about 10 minutes, as indicated by a caliper reading taken about 10 minutes after the compressive forces were removed.

### Example 3

A 20 gsm polypropylene spunbond nonwoven web, was initially thermally-bonded and then introduced into a pair of intermeshing rolls with a steel patterning roll having the pattern of hexagonal elements shown in FIG. 2. The distance between opposing pairs of parallel walls in the hexagonal elements of the pattern was about 11.3 mm. The nonwoven web had an 18% bond area and a width of 300 mm. The line speed was 20 m/min. The steel roll was held at a temperature of 130° C. The opposing rubber roll had a hardness of 75 SH-A and the nip pressure was 70 N/mm.

The process of forming three-dimensional hexagonal patterns generated a 440% increase in material bulk relative to the precursor material. After a 24 hour compression, the nonwoven recovered to 45% of its initial bulk after about 10 minutes, as indicated by a caliper reading obtained around 10 minutes after compressive forces were removed.

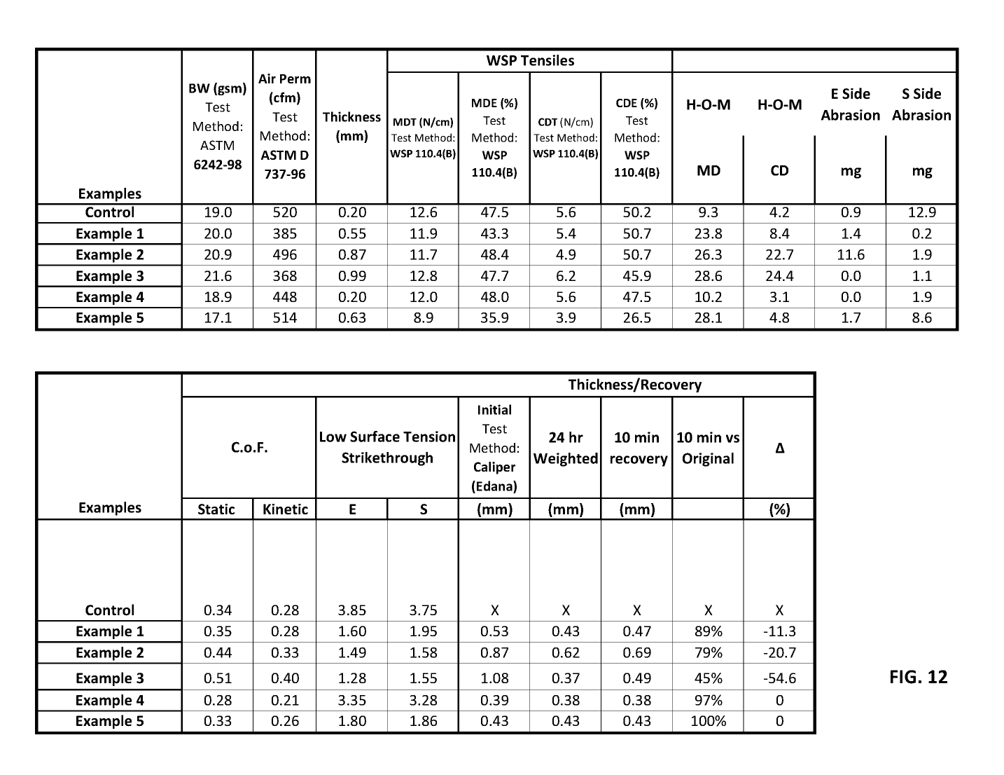

FIG. 12 shows a comparative table showing properties measured for Examples 1-3 described above (and additional Examples 4-5) as well as the properties of an unpatterned 20 gsm spunbond nonwoven web used as a control. The results are the average of the properties measured for six samples for each fabric.

The three-dimensionally patterned nonwoven webs of the invention were found to have a high degree of recovery when subjected to tensile stress. Specifically, the application of a tensile stress sufficient to flatten the protrusions of the web did not prevent the protrusions from recovering some of their initial bulk once the tensile stress was removed.

The recovery of a three-dimensionally patterned nonwoven web was demonstrated by using tensile testing equipment (supplied by Instron® Corporation) on a segment of nonwoven web approximately 50 mm wide and 152 mm long. Roughly 100 mm of the length of the nonwoven was subjected to a tensile stress. The nonwoven web was pulled in the machine direction at speed of 100 mm per minute, and the machine was stopped when the load reached 45 N. This stretched the material so as to substantially flatten the protrusions. The material was maintained at this tensile load for approximately 24 hours before being released. After release, the material recovered to a sufficient degree for the protrusions to regain their three-dimensionality and become visible.

A three-dimensionally patterned nonwoven web described herein may be used in any of various disposable absorbent products. In an exemplary embodiment, the three-dimensionally patterned nonwoven web may be used in a disposable diaper. For example, a disposable diaper may include a topsheet, an absorbent core, and a backsheet, wherein the topsheet is most proximate to the wearer's skin. The three-dimensionally patterned nonwoven web may be used as a topsheet, as a layer within a topsheet, or it may be attached to a section of a topsheet. In embodiments of the invention, the three-dimensionally patterned nonwoven web may be used as a backsheet, as a layer within a backsheet, or it may be attached to a section of a backsheet It will be understood that the three-dimensionally patterned nonwoven web may be applied to a diaper (or other product) with protrusions projection downward or upward (i.e. with concave or convex side facing the user).

In embodiments of the invention, the three-dimensionally patterned nonwoven web is provided on a wearable product on a surface that interfaces with a wearer's skin. The three-dimensionally patterned nonwoven web is preferably applied with the concave areas facing the wearer so that only the matrix of the nonwoven web contacts the wearer, with the protruded areas projecting away. The reduction of material contacting a wearer may enhance the comfort of the product.

Having described this invention with regard to specific embodiments, it is to be understood that the description is not meant as a limitation since further modifications and variations may be apparent or may suggest themselves to those skilled in the art. It is intended that the present application cover all such modifications and variations.

1. A nonwoven web made of substantially continuous fibers and comprising a three-dimensional pattern of protruding closed shapes, wherein the nonwoven web has a compression recovery of at least 30% after being compressed at 1 psi for 24 hours.

2. The nonwoven web of claim 1, wherein the nonwoven web has a compression recovery of at least 40% after being compressed at 1 psi for 24 hours.

3. The nonwoven web of claim 1, wherein the protruding closed shapes comprise shapes of a type selected from the group consisting of: hexagonal, circular and oblong.

4. The nonwoven web of claim 1, wherein the three dimensional pattern comprises a matrix that surrounds the protruding closed shapes.

5. The nonwoven web of claim 4, wherein portions of the nonwoven web that form the protruding closed shapes have a density that is less than that of portions of the nonwoven web that form the matrix.

6. The nonwoven web of claim 1, wherein the matrix that surrounds the protruding closed shapes forms a continuous, inter-connecting network.

7. The nonwoven web of claim 6, wherein the network is configured to hold the nonwoven web dimensionally stable under monoaxial and/or multi-axial stress.

8. The nonwoven web of claim 6, wherein the network is configured to allow the web to recover into its original dimensions after application of stress forces and release of the stress forces.

9. The nonwoven web of claim 4, wherein portions of the nonwoven web that form the protruding closed shapes have an air permeability that is higher than that of portions of the nonwoven web that form the matrix.

10. The nonwoven web of claim 4, wherein the matrix takes up 15% to 40% of an entire surface area of the nonwoven web.

11. The nonwoven web of claim 1, wherein the nonwoven web comprises one or more layers of substantially continuous fibers.

12. The nonwoven web of claim 1, wherein the nonwoven web is a spunbond, meltblown or spunbond-meltblown-spunbond web.

13. The nonwoven web of claim 1, wherein the nonwoven web is made from mono-component, bi-component or multi-component fibers.

14. The nonwoven web of claim 1, wherein the fibers are thermally pre-bonded, hydroentangled, air bonded or thermally tack bonded.

15. A method of manufacturing a nonwoven web comprising:
introducing a precursor nonwoven web comprised of substantially continuous fibers into a nip formed by a heated first roll comprising a pattern of cavities and a second roll comprising a deformable and resilient outer surface; and
pressing regions of the precursor nonwoven web into the cavities to plastically deform the precursor nonwoven web to form a three-dimensional pattern of protruding closed shapes on a surface of the precursor nonwoven web.

16. The method of claim 15, wherein pressure in the nip is within a range of 10 N/mm to 120 N/mm.

17. The method of claim 15, wherein the first roll is heated to a temperature of 80° C. to 150° C.

18. The method of claim 15, wherein the first roll is made of steel.

19. The method of claim 15, wherein the outer surface of the second roll is made of rubber.

20. The method of claim 15, wherein the cavities have a depth of 0.5 mm to 5.0 mm.

21. The method of claim 15, wherein the first roll comprises a matrix of interconnected surfaces that surround the cavities.

22. The method of claim 21, wherein the interconnected surfaces have a width of 0.5 mm to 2 mm.

23. The method of claim 15, wherein the cavities define closed shapes.

24. The method of claim 23, wherein the closed shapes comprise shapes selected from the group consisting of: circular, oval, square, hexagon, pentagon and octagon.

25. The method of claim 15, wherein the method further comprises prebonding the precursor nonwoven web prior to the introducing step.

26. A method of manufacturing a nonwoven web comprising:
introducing a precursor nonwoven web comprised of substantially continuous fibers into a first nip, formed by a heated first roll comprising a pattern of cavities and a second roll comprising a deformable and resilient outer surface, and a second nip, formed by the heated first roll and a third roll comprising a deformable and resilient outer surface; and
pressing regions of the precursor nonwoven web into the cavities in a synchronized manner along a circumferential portion of the first roll between the first and second nips to plastically deform the precursor nonwoven web in a repeating step to form a three-dimensional pattern of protruding closed shapes on a surface of the precursor nonwoven.

27. A method of manufacturing a nonwoven web comprising:
introducing a precursor nonwoven web comprised of substantially continuous fibers into two or more nips, each of the two or more nips comprising a heated first roll comprising a pattern of cavities and a respective second roll comprising a deformable and resilient outer surface; and
pressing regions of the precursor nonwoven web into the cavities in a synchronized manner along a circumferential portion of the first roll between the two or more nips to plastically deform the precursor nonwoven web in a repeating step to form a three-dimensional pattern of protruding closed shapes on a surface of the precursor nonwoven.
